(19) United States
(12) Patent Application Publication
(10) Pub. No.: US 2007/0118823 A1
(43) Pub. Date: May 24, 2007

(54) Method and system for automatically checking traces in segments

(75) Inventors: Lionel Zhao, Taipei (TW); Bg Fan, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/378,136

(22) Filed: Mar. 17, 2006

(30) Foreign Application Priority Data
Nov. 18, 2005 (TW) 094140533

(51) Int. Cl. G06F 17/50

(52) U.S. Cl. 716/5; 716/15

(57) ABSTRACT

A method and system for automatically checking traces of a differential pair in segments in a printed circuit board (PCB) layout is proposed. A setting module sets a tolerance of length difference. A checking module segments the differential pair into a plurality of segments at places where the slopes thereof change and obtains the length differences of corresponding pairs of segments. A determining module compares the length differences with the tolerance of length difference. A processing module marks a corresponding pair of segment if its length difference exceeds the tolerance of length difference.

### BACKGROUND OF THE INVENTION

1. Field of the Invention

The present invention relates generally to a method and system for automatically checking traces in segments, and more particularly, to a method and system for automatically checking the length differences of segments of differential pair traces in a printed circuit board (PCB) layout.

2. Description of Related Art

At present, in a printed circuit board (PCB) layout, in order to enable traces with the same kind of signals (e.g. differential pair traces) to transmit and receive signals synchronously, both traces in each of the differential pair traces need to be close in length, i.e., the length difference of which should be no larger than a predetermined tolerance of length difference.

However, the slope of the traces are generally altered several times in their routes, and it is common for the length of the external trace to be larger than that of the inner trace over a certain amount of distance. Thus, the length difference of the different pair traces may easily go beyond the predetermined tolerance of length difference and degrade signal quality. Therefore, it becomes important to check differential pair traces in segments, so as to make appropriate amendment in time.

However, no existing technology can automatically check the length difference of differential pair traces in segments. A designer has to segment different pair traces manually, and then check each individual segment. More particularly, the common segmentation approach is to segment a differential pair at where the slopes are altered, and take the initial positions of both traces on the same plane of a PCB as a beginning point, then measure length between the beginning point and a first segmenting point for each trace, and next calculate the length difference between the two traces. If the calculated length difference is beyond the tolerance of length difference, the shorter trace will be routed in detour so as to make up the length. Thus, it is a very time-consuming process.

Moreover, if the span of a differential pair trace is large, the traces are turned frequently, i.e. change its slope, manually checking the length difference of such different pairs in the method described above severely decreases work efficiency. In addition, with the increasing development of servers with higher speed, more and more differential pair traces are used. If the differential pair traces are still checked by the described conventional method, the PCB design time will be unfavorably extended, which may in turn delay the product complete time, thus generating considerably amount of loss.

Furthermore, when calculating the lengths of the differential pair traces, it is necessary to segment both traces at the positions where slopes are altered in order to measure the lengths of individual segments. However, different designers may segment the same trace at slightly different points due to the trace having a certain width, human visual error or dithering hand during segmentation. Segmenting a trace vertically or slantways may sometimes make a difference. Thereby, accuracy of manual segmentation is low.

Accordingly, there exists a strong need in the art for a method and system for automatically checking the length difference between traces segment by segment, so as to save time and enhance work efficiency and segmentation accuracy, and also enable signals on the traces to be communicated synchronously.

### SUMMARY OF THE INVENTION

Accordingly, it is an objective of the present invention to solve the drawbacks of the above prior art by providing a method and system for checking traces in segments which can automatically check length differences of a differential pair traces segment by segment without manual involvement, so as to save time, enhance work efficiency and accuracy.

It is another objective of the present invention to provide a method and system for automatically checking traces in segments, when determining the length difference of a corresponding pair of segments is beyond tolerance of length difference, the segments can be amended in time, so that layout is made easy.

In order to attain the objectives mentioned above and the others, a method and system for automatically checking traces in segments in a printed circuit board (PCB) layout. The method comprises: (1) setting a tolerance of length difference; (2) identifying a set of check points on a pair of traces as a corresponding pair of segments; (3) measuring the lengths of the corresponding pair of segments, and calculating the length difference between the corresponding pair of segments; (4) determining whether the calculated length difference exceed the tolerance of length difference, if yes, proceeding to step (5), if not, proceeding to step (6); (5) marking the corresponding pair of segments for amendment by an operator, then proceeding to step (6) after finishing amendment; and (7) determining whether the corresponding pair of segments is the last one of the pair of traces, if not, returning to step (2), if yes, completing the process.

In one embodiment of the present invention, the step of identifying the check points comprises identifying the ends of the traces or positions where slopes of the traces change. The step of marking the corresponding pair of segments comprises highlight or coloring. The amendment comprises detouring the shorter segment of the marked corresponding pair of segments so that the length difference between the corresponding pair of segments after amendment does not exceed the tolerance of length difference.

The system comprises a setting module for setting a tolerance of length difference; a checking module for identifying corresponding pairs of segments, measuring lengths of the corresponding pairs of segments, and calculating the length differences of the corresponding pairs of segments; a determining module for comparing the length differences calculated by the checking module with the tolerance of length difference set by the setting module, and determining whether length differences are larger than the tolerance of length difference, so as to output a determining signal; and a processing module for processing based on the determining signal outputted from the determining module, wherein if the length difference of one of the corresponding pairs of segments exceeds the tolerance of length difference, marking said corresponding pair of segments for subsequent amendment.

Compared with the conventional technology, the method and system for automatically checking traces in segments according to the present invention mainly takes the positions where slopes of various pending checking traces are altered for check points to automatically check with segmentation, thereby measuring lengths from various check points to the beginning end step by step and calculating length difference with one another, then determining whether length difference is larger than the tolerance of length difference, if yes, marking the checked traces for the subsequent amendment, then proceeding to check the next check point after finishing amendment.

The method and system for checking traces in segments according to the present invention can automatically check length difference of pairs of traces segment by segment. Such checking operation can be finished quickly without manual involvement. The present invention is particularly advantageous for a large number of traces, in which time can be saved considerably and human error in identifying check points of the traces can be eliminated. In addition, since the traces are checked segment by segment, corrections can also be made segment by segment, thus traces layout is made easy.

### BRIEF DESCRIPTION OF DRAWINGS

FIG. 1 depicts a schematic block diagram of the basic structure of the system for checking traces in segments according to the present invention.

FIG. 2 depicts a pair of traces in the system for checking traces in segments according to the present invention.

FIG. 3 is a flow chart illustrating the method for checking traces in segments according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention.

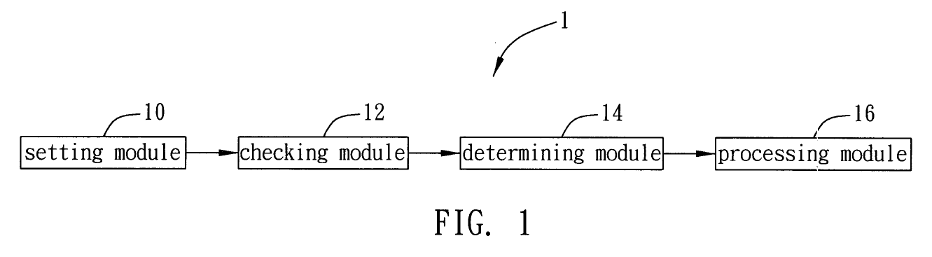

With reference to FIG. 1, shown is a schematic diagram of the basic structure of the system for automatically checking traces in segments according to the present invention. The system for automatically checking traces in segments 1 according to the present invention is applied in a printed circuit board (PCB) layout, and is used to check the length differences of a plurality of differential pair traces on the same plane, such checking operation can be finished quickly without manual involvement. As shown in FIG. 1, the system for automatically checking traces in segments 1 according to the present invention comprises a setting module 10, a checking module 12, an determining module 14 and a processing module 16. The system for automatically checking traces in segments 1 will be described in more details below.

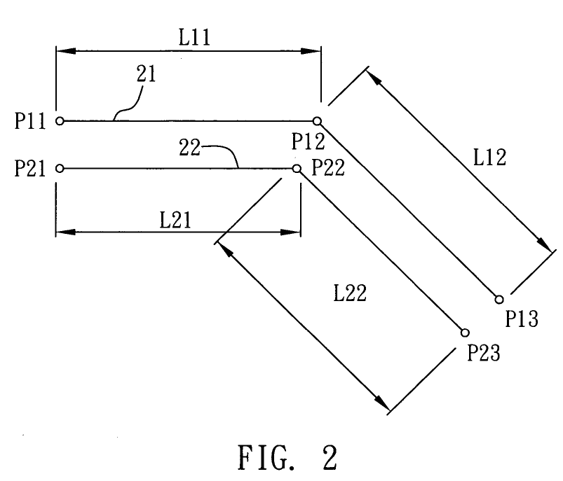

With reference to FIG. 2, the setting module 10 sets a tolerance of length difference and a plane of the PCB to be checked, and also defines the two ends of the differential pair traces 21, 22 as the beginning points P11, P21 and stopping points P13, P23, respectively. In the exemplary embodiment, the beginning points may correspond to transmitting terminals of the traces, and the stopping points may correspond to the receiving terminals of the traces, but is not limited to this, the beginning points can be the receiving terminals, and the stopping points can be the transmitting terminals instead.

The checking module 12 identifies check points P12, P22 along the differential pair traces 21, 22 from the beginning points P11, P21 (i.e. forming segments L11, L21 on traces 21, 22). The check points are considered to be positions where the slopes of the differential pair traces alter (e.g. points P12, P22) as well as the stopping points (e.g. points P13, P23). After identifying the check points along the entire traces, the checking module 12 measures the lengths L11, L21 of the differential pair traces 21, 22 from the beginning points P11, P21 to the check points P12, P22, and calculates the length difference between the lengths L11, L21. The length difference between segments L12, L22 from the check points P12, P22 to the stopping (or check) points P13, P23 is obtained in a similar fashion. It should be noted that although two segments of the traces are shown in this embodiment, the present invention is not limited to this number, but can have more segments that are identified, measured and calculated in the same way as the above.

The determining module 14 is used to compare the length difference (e.g. the difference between L11 and L21) calculated by the checking module 12 with the tolerance of length difference set by the setting module 10, and determining whether the length difference is larger than the tolerance of length difference, so as to output a determining signal.

The processing module 16 is used to take appropriate actions based on the determining signal outputted from the determining module 14. In one embodiment, when it is determined that the length difference of a differential pair has exceeded the tolerance of length difference, marking the checked differential pair traces for amendment, then proceeding to check the next check point after finishing amendment. These processes are repeated until the last pair of segments of the traces has been checked. More particularly, the checked traces are marked by highlighting or coloring; alternatively, other methods can be used as long as the design can identify the traces to be re-routed. In addition, in one embodiment, the amendment for the marked traces may comprise: making up the shorter trace (e.g. trace 22 in this example) among traces, of which length difference has exceeded the tolerance of length difference, by detouring, such as in the snake winding pattern, so as to ensure the length difference between the shorter trace 22 and the longer trace 21 does not exceed the tolerance of length difference. In one embodiment, the snake winding pattern has a fixed format, generally adding an extra five millimeters (mil) to the traces.

The system for automatically checking traces in segments 1 according to the present invention is further illustrated using the differential pair traces 21, 22 as an example. First, a tolerance of length difference (assuming to be 30 mil) is predetermined through the setting module 10, and the plan to be checked is selected from the PCB, meanwhile transmitting terminals and receiving terminals of the differential pair are respectively defined as the beginning and stopping points for checking subsequently, then, by the checking module 12, the positions at which slopes of the two traces 21, 22 alter are automatically identified as the check points so that the traces can be automatically checked segment by segment, such as traces L11 and L12, and traces L21 and L22, thereby measuring various lengths segment by segment, and calculating length differences between a corresponding pair of segment (such as between L11 and L21, or L12 and L22). Thereafter, the determining module 14 determines whether the length difference is larger than 30 mil, if yes, the processing module 16 marks the checked traces by highlighting or coloring for subsequent amendment of the shorter trace, then continues to check the next pair of segments after finishing amendment, if not, continues to check the next pair of segments, when the check points are the stopping points, completes the process.

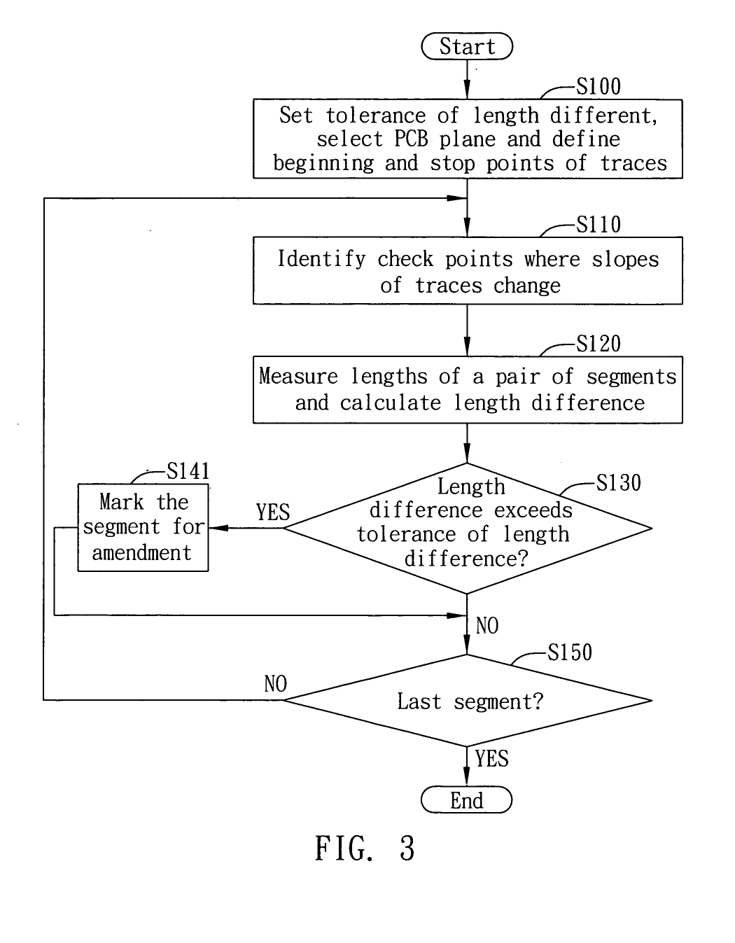

With reference to FIG. 3, shown is a flow chart of the method for automatically checking traces in segments according to the present invention applied in a printed circuit board (PCB) layout. The method is used to check the length difference of a plurality of differential pair traces on the same plane of the PCB. As shown, the method begins at step S100, setting a tolerance of length difference, and selecting the plane to be checked from the PCB, meanwhile respectively defining the two ends of the differential pair traces as the beginning points and the stopping points. In the exemplary embodiment, the beginning points can be transmitting terminals of the traces, and the stopping points are receiving terminals, or vice versa, then proceed to step S110.

At step S110, taking FIG. 2 for example, identifying a set of check points (e.g. point P12 ) at positions where slopes of the traces alter or at the stopping end along the differential pair traces from the beginning points (e.g. P11), then proceed to step S120.

At step S120, taking FIG. 2 for example, measuring the lengths (e.g., L11 and L21) of the differential pair traces from the beginning point to the check points, and calculating the length difference (subtracting L12 from L11) between the first segment of the differential pair traces, then proceed to step S130.

At step S130, determining whether the length difference is larger than the tolerance of length difference, if yes, proceed to step S141, if not, proceed to step S150.

At step S141, marking the checked traces for subsequent amendment and performing the appropriate operation such as adding more length to the short segment of the differential pair, then proceed to step S150.

At step S150, determining whether the current set of check points is the stopping points of the differential pair traces, if not, returning to step S110; if yes, the process ends.

As described above, the method and system for automatically checking traces in segments according to the present invention identifies the positions where the slopes of the traces of a differential pair change to automatically segment traces into segments, obtains the length differences of corresponding segment pairs and determines whether the length differences are larger than a predetermined tolerance of length difference, if yes, marks the segments that exceed the tolerance so that an operator may re-route the problematic segments being marked.

Applications of the method and system for automatically checking traces in segments according to the present invention can automatically check length differences among various traces segment by segment without manual involvement. The present invention is particularly advantageous for a large number of traces, in which time can be saved considerably and human error in identifying check points of the traces can be eliminated. In addition, since the traces are checked segment by segment, corrections can also be made segment by segment, thus traces layout is made easy.

The above-described exemplary embodiments are to describe various objects and features of the present invention as illustrative and not restrictive. A person of ordinary skilled in the art would recognize that modifications and changes could be made in form and detail without departing from the spirit and the scope of the invention. Thus, the right protective scope of the present invention should fall within the appended claim.

What is claimed is:

1. A method for automatically checking traces in segments in a printed circuit board (PCB) layout, the method comprising:
(1) setting a tolerance of length difference;
(2) identifying a set of check points on a pair of traces so as to determine a corresponding pair of segments;
(3) measuring lengths of the corresponding pair of segments, and calculating a length difference between the corresponding pair of segments;
(4) determining whether the calculated length difference exceeds the tolerance of length difference, if yes, proceeding to step (5), if not, proceeding to step (6);
(5) marking the corresponding pair of segments for amendment by an operator, then proceeding to step (6) after finishing amendment; and
(7) determining whether the corresponding pair of segments is the last one in the pair of traces, if not, returning to step (2), if yes, completing the process.

2. The method of claim 1, wherein the step (2) of identifying the check points comprises identifying ends of the traces or positions where slopes of the traces change.

3. The method of claim 1, wherein the step (5) of marking the corresponding pair of segments comprises highlight or coloring.

4. The method of claim 1, wherein the amendment comprises detouring a shorter segment of the marked corresponding pair of segments so that the length difference between the corresponding pair of segments after amendment does not exceed the tolerance of length difference.

5. A system for automatically checking traces in segments in a printed circuit board (PCB) layout, the system comprising:
a setting module for setting a tolerance of length difference;
a checking module for identifying corresponding pairs of segments, measuring lengths of the corresponding pairs of segments, and calculating length differences of the corresponding pairs of segments;
a determining module for comparing the length differences calculated by the checking module with the tolerance of length difference set by the setting module, and determining whether the length differences are larger than the tolerance of length difference, so as to output a determining signal; and
a processing module for processing based on the determining signal outputted from the determining module, if the length difference of one of the corresponding pairs of segments exceeds the tolerance of length difference, marking said corresponding pair of segments for subsequent amendment.

6. The system of claim 5, wherein the segments are between points where slopes of the traces change or between points where slopes of the traces change and ends of the traces.

7. The system of claim 5, wherein the corresponding pair of segments is marked by highlighting or coloring.

8. The system of claim 5, wherein the amendment comprises detouring a shorter segment of the marked corresponding pair of segments so that the length difference between the corresponding pair of segments after amendment does not exceed the tolerance of length difference.
